(19) United States
(12) Patent Application Publication
(10) Pub. No.: US 2026/0257947 A1
(43) Pub. Date: Sep. 3, 2026

(54) Active Material For Use In Single Stage Wastewater Treatment

(71) Applicant: Andriy B Khotkevych, Duluth, MN (US)

(72) Inventor: Andriy B Khotkevych, Duluth, MN (US)

(21) Appl. No.: 19/066,300

(22) Filed: Feb. 28, 2025

(51) Int. Cl. C02F 1/52; B01J 20/04; B01J 20/20; B01J 20/32; C02F 1/28; C02F 101/10; C02F 103/10

(52) U.S. Cl. CPC C02F 1/5236; B01J 20/041; B01J 20/20; B01J 20/3234; C02F 1/281; B01J 2220/58; C02F 2101/101; C02F 2101/105; C02F 2103/10

(57) ABSTRACT

An active material comprising calcium hydroxide immobilized thereon for use in a single stage wastewater treatment for the removal of inorganic contaminants via column filtration. The active material can be a high-surface porous carbonaceous carrier, such a Hunnam biochar. The inorganic contaminants include phosphates and sulfates found in industrial wastewater, particularly wastewater resulting from mining operations.

### FIELD OF INVENTION

The present invention relates to a single stage wastewater treatment for the removal of inorganic contaminants utilizing calcium hydroxide which has been immobilized on an active material, such as a carbonaceous carrier. More particularly, the present invention relates to a single stage treatment of wastewater derived from mining operations by passing the mining wastewater through a high-surface porous carbonaceous carrier having calcium hydroxide immobilized thereon via column filtration to remove inorganic contaminants.

### BACKGROUND OF THE INVENTION

Wastewater derived from mining operations, commonly referred to mining wastewater, contains numerous inorganic contaminants, such as copper that can be present at low levels from 0.1 to 10 mg/L. Other inorganic contaminants include, for example, arsenic, cobalt, cadmium, lead, selenium, silver, zinc, phosphates, and sulphates. Sulphates are a common by-product found in mining wastewater and have increasingly become a contaminant of concern and the subject of regulatory controls. A major water quality concern related to mining is the formation of acid rock drainage (ARD), sometimes also called acid mine drainage. ARD results from the reaction of water and oxygen with sulfide minerals (pyrite, pyrrhotite, etc.) contained in mined or exposed rock. Accordingly, sulphate concentrations tend to be much higher and can range upwards of 1,000 to 2,000 mg/L.

### PRIOR ART

The prior art is replete with examples for treating wastewater resulting from mining operations. Such treatments all require multistage processes such as sedimentation, filtration, and chemical precipitation. With mining wastewater containing a high content of sulfates, the removal of the sulfates requires large amounts of reagents and continuous monitoring throughout the several stages which has resulted in prohibitive costs.

Many treatments have been developed to remove contaminants from wastewater and sewage effluent, typically by means of multi-step processes. For example, U.S. Pat. No. 3,716,484 to Lincoln et al. describes a multi-step process for the substantial removal dissolved phosphates from wastewater comprising first adding calcium hydroxide to the wastewater to create an alkaline wastewater having a pH from 8 to 9.5, then adding calcium chloride to create a precipitate of insoluble phosphates which then are removed from the alkaline wastewater. A drawback to Lincoln et al. is that only about 80% of the phosphates are precipitated and removed from the alkaline wastewater. A second drawback to Lincoln et al. is the multi-step treatment does not remove sulfates and other inorganics from the alkaline wastewater.

U.S. Pat. No. 5,266,210 to Mclaughlin is directed to another multi-stage process for the removal of heavy metals from wastewater. In a first stage, calcium oxide and/or calcium hydroxide is added to adjust the pH such that various metals become insoluble. Mclaughlin notes that gypsum formation may also occur is sulfate ions are present in the wastewater. In the second stage, sodium carbonate is added in the form of soda ash to enable the formation of calcium carbonate. In the third stage of Mclaughlin's four step process, a coagulant preferably a non-ionic or slightly anionic polymer is added to aid in the precipitation of solids to form a sludge comprising calcium carbonate, heavy metals, and gypsum. After the precipitation of heavy metals and the formation of sludge, substantially all water is separated from the resultant sludge as a supernatant which is then treated in a fourth stage with the addition of a suitable acid to adjust the pH of the water. An obvious drawback to Mclaughlin is the four-stage process to remove heavy metals from wastewater. In addition, in Mclaughlin's second step, gypsum formation is substantially halted which indicates that the removal of sulfates is not a priority of Mclaughlin.

Of lesser interest, CN 102020345 A generally relates to the application of calcium hydroxide in drink water treatment in order to improve the pH of the water body, thereby lowering production costs. In a publication by Choi et al., published online on Oct. 29, 2018, a research study investigated the use of a calcium hydroxide-coated dairy manure derive biochar (Ca-BC) for the adsorption of phosphate from water and dairy wastewater which showed a higher adsorption of phosphate that that of a dairy manure-derived biochar. The biochar was limited to the removal of phosphates from the dairy wastewater.

Both Lincoln et al. and Mclaughlin provide multi-step treatment processes which require the formation and removal of a precipitate sludge from a wastewater and necessitate the high consumption of chemical reagents and continuing monitoring of those reagents. Neither Lincoln et al. and Mclaughlin provide a material for a single-step wastewater treatment which removes phosphates and sulfates. While Choi et al. does provide a material rather than a process, the dairy manure-derived biochar is limited to the removal of phosphates.

### SUMMARY OF THE INVENTION

The present subject matter relates to a single stage wastewater treatment for the removal of inorganic contaminants utilizing an active material, such as a high-surface porous carbonaceous carrier, upon which calcium hydroxide has been immobilized. Among the inorganic contaminants found in wastewater derived from mining operations are phosphates and a high content of sulfates due to acid rock drainage (ARD).

It is an object of the present invention to provide a single stage wastewater treatment for the removal of inorganic contaminants using an active material upon which calcium hydroxide has been immobilized.

It is another object of the present subject matter to a single stage wastewater treatment to provide an active material in the form of a high-surface porous carbonaceous carrier having immobilized calcium hydroxide to remove inorganic contaminants from mining wastewater.

It is yet another object of the present invention to provide a single stage wastewater treatment using an active material such as a high-surface porous carbonaceous carrier having immobilized calcium hydroxide to remove phosphates and sulfates from mining wastewater.

It is a still another object of the present invention to provide a single stage wastewater treatment an active high-surface porous carbonaceous carrier having immobilized calcium hydroxide to remove sulfates from high content sulfate mining wastewater.

It is yet another object of the present invention to provide a single stage wastewater treatment for the removal of inorganic contaminants including phosphates and sulfates using column filtration.

It is an additional object of the present invention to provide an active material in the form of a high-surface porous carbonaceous carrier having immobilized calcium hydroxide to remove sulfates from a high content sulfate wastewater in a single stage and cost-effective treatment.

These and other objects of the present subject matter are achieved by providing a single stage wastewater treatment for the removal of inorganic contaminants using an active material in the form of a high-surface porous carbonaceous carrier upon which calcium hydroxide has been immobilized. To remove the inorganic contaminants, including the high concentration of sulfates, the wastewater is passed through the high-surface porous carbonaceous carrier having calcium hydroxide immobilized thereon via column filtration.

### BRIEF DESCRIPTION OF DRAWINGS

FIG. 1 is a flow diagram of the single wastewater treatment of the present subject matter using an active material via column filtration.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

Also, it is to be understood that the phraseology and terminology used herein is for the purpose of description and should not be regarded as limiting. The use of the terms “including”, “comprising”, “having”, and variations thereof herein is meant to encompass the items listed thereafter and equivalents thereof as well as additional items.

The present subject matter is directed to a single stage wastewater treatment for the removal of phosphates and sulfates from industrial wastewater, particularly wastewater containing a high content of sulfates. More particularly, the industrial wastewater is derived from mining operations. The single state wastewater treatment utilizes an active material upon which calcium hydroxide can be immobilized thereon. In a preferred embodiment, the active material can be a high-surface porous carbonaceous carrier, an example of which is a biochar. However, as will be obvious to those skilled in this field of the art, any active material capable of having calcium hydroxide immobilized thereon is suitable for use in the present single stage wastewater treatment.

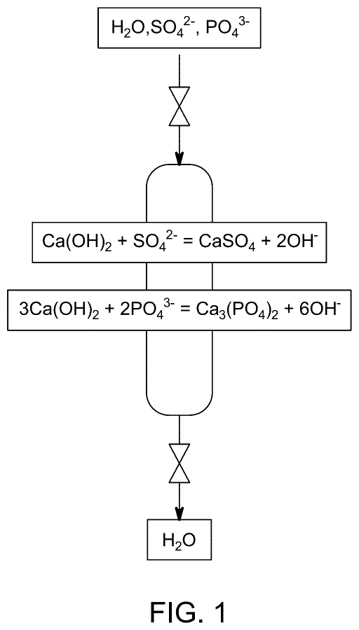

As illustrated in FIG. 1, industrial wastewater containing inorganic contaminants including sulfates and phosphates is passed through an active material having the calcium hydroxide immobilized thereon via column filtration. During the filtration process, the calcium hydroxide molecules react with the contaminants in the wastewater to form calcium compounds. For example, the calcium hydroxide molecules react with the sulfates contaminants in the wastewater to form calcium sulfates and the calcium hydroxide molecules react with the phosphates contaminants in the wastewater to form calcium phosphates. The bound calcium-containing compounds including the calcium sulfates and calcium phosphates are captured on the surface of the active material and the effluent water is extracted from the column filtration.

### Example 1. Preparation of the Active Material

For the preparation of the active material, 100.0 g of biochar was placed in a beaker containing 500.0 ml of saturated lime water. The mixture was stirred 15 minutes at ambient temperature, and then filtered on a Buchner's funnel. The resultant solids were dried in a hood at 80° C. resulting in a yield of 100.8 g of dried matter. The biochar is a wood-derived biochar, more specifically Black Earth Biochar™.

### Example 2. Performance Test—Phosphates

5.0 g of active material was placed on the bottom of a standard 100 ml burette, and then the test solution, containing 600 ppb of total phosphates was passed downstream the system, collecting effluent samples each 10 ml. Test solution and effluent samples were monitored on phosphates content with Hanna™ HI736 Phosphate Checker according to the manufacturer's manual. The results are shown in the below table.

| Sample # | Test solution passed, ml | Phosphates found, ppb |
|---|---|---|
| 1 | 10 | Not found |
| 2 | 20 | Not found |
| 3 | 30 | 18 |
| 4 | 40 | 22 |
| 5 | 50 | 26 |
| 6 | 60 | 40 |

### Example 3. Performance Test—Sulfates

5.0 g of active material was placed on the bottom of a standard 100 ml burette, and then the test solution, containing 1.48 g/l of Sodium Sulfate (equivalent of 1000 ppm of sulfate ions) was passed downstream the system, collecting effluent samples each 5 ml. The samples were monitored on sulfates residue by means of test reaction with aqueous Barium Chloride. The results are shown in the below table.

| Sample # | Test solution passed, ml | Sulfates presence |
|---|---|---|
| 1 | 5 | Not found |
| 2 | 10 | Not found |
| 3 | 15 | Not found |
| 4 | 20 | Traces |
| 5 | 25 | Traces |
| 6 | 30 | Traces |

While several illustrative embodiments of the invention have been shown and

described, numerous variations and alternative embodiments will occur to those skilled in the art. Such variations and alternative embodiments are contemplated and can be made without departing from the scope of the invention as defined in the appended claims.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S.C § 112, sixth paragraph, unless the element is expressly recited using the phrase “means for . . . ” and no method or process step herein is to be construed under those provisions unless the step, or steps, are expressly recited using the phrase “step(s) for . . . .”

1. An active material comprising calcium hydroxide immobilized thereon, said active material utilized in a single stage wastewater treatment for the removal of inorganic contaminants via column filtration.

2. The active material in accordance with claim 1, wherein said active material is a high-surface porous carbonaceous carrier.

3. The active material in accordance with claim 1, wherein said inorganic contaminants include phosphates and sulfates.

4. The active material in accordance with claim 2, wherein said inorganic contaminants include phosphates and sulfates.

5. The active material in accordance with claim 2, wherein said high-surface porous carbonaceous carrier is a biochar.

6. The active material in accordance with claim 5, wherein said biochar is a wood-derived biochar.

7. The active material in accordance with claim 6, wherein said wood-derived biochar is Black Earth Biochar™.

8. The active material in accordance with claim 1, wherein said inorganic components are contained in wastewater derived from mining operations.

9. A single stage wastewater treatment for the removal of inorganic contaminants contained in industrial wastewater comprising passing said industrial wastewater through an active material having calcium hydroxide immobilized thereon via column filtration.

10. The single stage wastewater treatment in accordance with claim 9, wherein said active material is a high-surface porous carbonaceous carrier.

11. The single stage wastewater treatment in accordance with claim 9, wherein said high-surface porous carbonaceous carrier is a biochar.

12. The single stage wastewater treatment in accordance with claim 9, wherein said high-surface porous carbonaceous carrier is a wood-derived biochar.

13. The single stage wastewater treatment in accordance with claim 9, wherein said inorganic contaminants include sulfates and phosphates.

14. The single stage wastewater treatment in accordance with claim 13, wherein sulfates contaminants react with calcium hydroxide on said active material to form calcium sulfates which are captured on said active material.

15. The single stage wastewater treatment in accordance with claim 13, wherein phosphates contaminants react with calcium hydroxide on said active material to form calcium phosphates which are captured on said active material.

16. The single stage wastewater treatment in accordance with claim 13, wherein said industrial wastewater is wastewater containing sulfates contaminants and phosphates contaminants resulting from mining operations.
